(19) United States
(12) Patent Application Publication
(10) Pub. No.: US 2009/0188721 A1
(43) Pub. Date: Jul. 30, 2009

(54) Membrane method of making drilling fluids containing microbubbles

(76) Inventor: Kevin W. Smith, Houston, TX (US)

Correspondence Address: William L. Krayer, 1771 Helen Drive, Pittsburgh, PA, 15216, US

(21) Appl. No.: 12/322,155

(22) Filed: Jan. 29, 2009

Related U.S. Application Data
(60) Provisional application No. 61/062,932, filed on Jan. 30, 2008.

(51) Int. Cl. C09K 8/38; C09K 8/02; E21B 21/14; E21B 7/00

(52) U.S. Cl. 175/66; 507/102

(57) ABSTRACT

Drilling fluid is reduced in density while under pressure and prior to injection in the well by creating microbubbles of gas formed on transportation through a membrane while maintaining a transmembrane pressure difference sufficient to create the microbubbles.

### RELATED APPLICATION

This application claims the full benefit of provisional application 61/062,932 filed Jan. 30, 2008, which is incorporated herein in its entirety.

### TECHNICAL FIELD

Microbubbles are created and dispersed in fluids used for drilling wells. The microbubbles are useful for any drilling fluid, but are particularly suited for creating light to middle weight aqueous fluids in the range of 4-8 pounds per gallon and particularly 4-6 pounds per gallon. The microbubbles are created by diffusing air through a microporous membrane tube wall into the drilling fluid under pressure.

### BACKGROUND OF THE INVENTION

In the drilling of wells for hydrocarbon recovery, fluids are circulated in wellbores during drilling, primarily to remove drill cuttings, lubricate the bit and prevent collapse of the wellbore. The fluids can range in weight from very near zero (gas) to as high as 24 pounds per gallon, for which weighting agents are added to liquid to impart a high specific gravity to assure the cuttings will have buoyancy in the fluid. A major factor in the choice of the weight of the fluid over this wide range is the pressure in the formation through which the wellbore is drilled. As a general rule, where the pressure in the formation is high, a heavier fluid will be used; if the pressure in the formation is relatively low, a lighter weight fluid will be prescribed for a balanced or underbalanced drilling process, in order not to injure the formation. A lighter fluid may be desirable also if the wellbore passes through a stratum of relatively low pressure even though the pressure may increase at greater depths, in order not to lose fluid unnecessarily into the formation in the low pressure area. In either case, the pump that circulates the fluid must be able to overcome the pressures of the formation as well as circulate the fluid. A triplex pump is commonly used for injecting and circulating the drilling fluid in the well.

Water weighs about 8.33 pounds per gallon, and has been used for decades in many different kinds of drilling environments by itself and as a base for many different kinds of drilling fluids, sometimes called drilling muds. Foaming agents have been used to reduce the weight of various aqueous drilling fluids. The industry has used foams of various types that are effective for limited or specified purposes, but a foam has a high percentage of gas and a small percentage of liquid and accordingly tends to weigh less than 2 pounds per gallon. In many situations, the ability of foam to carry drill cuttings is limited.

Foam is a distinct form of fluid. Foam is defined as bubbles in contact with one another such that the bubbles must deform for the fluid to move. Foams are true Bingham Plastic fluids typically with a very high yield point and plastic viscosity. While they can be very efficient fluids in well drilling, they are much harder to control than gas-free fluids. That is, one must control the pressure of the annular space so that the volume of gas does not expand to the point that the volume limit of the foam is exceeded and the bubbles interfere with one another. Typically foam has 62% to 90% gas by volume at a given pressure, and foam that is about 75% by volume gas has better fluid properties than most other foams. There are recently developed methods to control annular pressure, but still there is a pressure differential from the bit to the surface. Controlling the annular pressure is further complicated by the need to remove cuttings from the system. Foam has a further disadvantage in high friction. Since the bubbles must deform to move, there is high wall friction inside of the drill pipe. Therefore it is common to try to make the foam at the drill bit to avoid contact of the foam with the drill pipe; however, there is less control of the fluid since gravity can cause the gas and liquid to arrive at the bit in slugs.

Light, non-foaming drilling fluids in the range of 4-8, or especially 4-6 pounds per gallon would be desirable in many situations because a lighter hydrostatic column means the drilling can proceed at a faster pace and frequently with less energy expended. Such a light, non-foaming, fluid would be able to carry the cuttings efficiently, but is not practically available in the industry. A practical way to make such a fluid has eluded the art.

As is known in the art, aerated drilling systems used in the past—that is, foam systems—inject the air after, downstream of, the triplex pump, because the triplex pump is liable to form large bubbles by coalescing small ones, which can cause major damage to the pump and/or otherwise cause a disruption of the system if the air is injected by conventional means ahead of or in the triplex pump. Air injection systems used in the past have themselves been a large part of the problem. The triplex pump may become locked if a large bubble of air passes into it or is formed within it by cavitation or any other phenomenon such as simple coalescence. Even a centrifugal pump is highly likely to become air locked if more than 6% air by volume is introduced into the pump by way of conventional form-forming aeration systems.

A practical way of placing non-foam bubbles in the fluid to decrease the weight of the fluid downstream of the triplex pump, in the high pressures present, has eluded the art. The range of drilling fluid weights from about 4 to about 6 pounds per gallon has been especially difficult to attain by any means. Likewise, a convenient way of reducing the weight of fluids containing desirable heavy components has eluded the art.

### SUMMARY OF THE INVENTION

My invention provides a method of reducing the weight of virtually any drilling fluid, a method specifically of making a drilling fluid having a weight of 4-8 or especially 4-6 pounds per gallon, a method of reducing the weight of a drilling fluid by at least 20% without creating a foams and methods of drilling a well using such fluids.

My invention provides a method of injecting a gas into a drilling fluid prior to sending the fluid down a wellbore, and controlling the weight of the fluid during its use and recycle. It also provides a new method of making drilling fluid compositions containing microbubbles of substantially uniform size which may be maintained in a dispersed condition while the fluid is in use. And, it provides a new method of drilling a well using fluids containing microbubbles.

In addition to satisfying the primary objective of providing a light weight fluid, using microbubbles provides a number of advantages compared to foam. Microbubbles do not need to deform to flow; therefore, the carrier fluid determines the properties of the microbubble suspension. Contrary to the use of foam, microbubbles will reduce friction—that is, resistance to flow due to contact with conduit walls.

The microbubbles are injected into the drilling fluid by forcing gas through the pores of a microfilter, microporous membrane, or other microporous medium, any or all of which may be referred to herein as a membrane tube or a microporous membrane, or sometimes simply a membrane as will appear and/or be explained elsewhere herein. My invention is applicable to aqueous (including the great variety of brines commonly used in the oilfield industry) and nonaqueous (substantially water-free) drilling fluids and any other liquid drilling fluid. Its effectiveness may be expressed not only in terms of density of the fluid (achieving densities of 4-6 or 4-8 pounds per gallon, for example), but also in terms of a percent reduction in density—reducing the density of the fluid by at least 20%, and commonly 25% to 50%. The microbubbles are introduced to the base drilling fluid while it is under a pressure of at least 100 psi or perhaps at least 250 psi; the source gas for the microbubbles is maintained at a somewhat higher pressure than the drilling fluid, on the gas side of the membrane.

### BRIEF DESCRIPTION OF THE DRAWINGS

FIG. 1 is a flow sheet for illustrating the invention.

FIG. 2 is an enlarged, but still simplified, view of a membrane tube vessel.

FIG. 3 shows a membrane tube following a tortuous path.

FIG. 4 is a variation of the invention providing for the increasing volume of the drilling fluid as it becomes filled with microbubbles.

In FIG. 5, gas such as air is fed through membrane tubes and the base drilling fluid absorbs microbubbles from the outsides of the membrane tubes.

FIG. 6 illustrates an optional series of membrane tubes and optional applications of more than one gas pressure.

### DETAILED DESCRIPTION OF THE INVENTION

As is known in the art, a triplex pump is able to send the drilling fluid down the well to the bottom where the drill is creating cuttings, so the fluid will pick up the cuttings, and raise them to the surface. At the same time, the pump must overcome the formation pressure. The downhole pressure may typically be in the order of 2000 psi (pounds per square inch) or more, as much as 5000 psi, causing any bubbles present in the drilling fluid to be compressed and reduced in volume. This compressing effect in turn increases the ratio of liquid to gas in the fluid, which increases the weight of the fluid per gallon and defeats the main purpose of introducing bubbles if they are introduced at atmospheric pressure.

Bearing in mind that fresh water weighs about 8.33 pounds per gallon (ppg), that water is essentially incompressible, and that my objective is to obtain a fluid in the well having a weight of 4-6 ppg (or otherwise considerably lower than the base drilling fluid), a gallon of water containing bubbles (assuming the bubbles are weightless regardless of their compressed state) requires that the bubbles occupy from 28% to 52% of the volume of the fluid after injection, at a high pressure, without forming a foam. The volume of the gas bubbles is inversely related to the pressure according to the Ideal Gas Law, PV=nRT, where P is pressure, V is volume, n is the amount of gas, which may appear in terms of the number of molecules of gas, T is the temperature, and R is a constant. The difficulty of the problem, therefore, may be seen if it is imagined that one is attempting to introduce enough bubbles at atmospheric pressure so that a gallon of drilling fluid subjected to a pressure, for example, of 2000 psi or higher, will contain dispersed bubbles comprising from 28% to 52% of its volume. A bubble introduced or present in the fluid at atmospheric pressure (14.7 psi) but later subjected to a pressure of 2000 psi would be compressed by a factor of 2000/14.7 or 136 (although a high downhole temperature will have a somewhat mitigating effect), which means that if a large number of compressed bubbles are present in a gallon of fluid at 2000 psi (now weighing, say, 5 pounds per gallon and 40% of its volume is bubbles), the bubbles must have a total volume of 0.4×136 gallons, or more than 54 gallons at atmospheric pressure.

Air is not weightless, however, and a large number of gallons of compressed air in a gallon of fluid will affect its density. On the other hand, after the air or other gas introduced on the earth's surface at atmospheric pressure is compressed at, say, 2000 or 4000 psi in the wellbore, the ratio of liquid to gas is greatly increased, tending to defeat the purpose of reducing the density by introducing bubbles.

This phenomenon is illustrated in Examples 1-3. Examples 1, 2, and 3 are taken from U.S. patent application Ser. No. 12/313,947 filed Nov. 26, 2008 and owned by the assignee of the present invention. They represent calculations rather than actual experiments.

### EXAMPLE 1

Here, air bubbles having a volume of 0.001 cubic inch are introduced into the drilling fluid. That is, each bubble has a volume equivalent to a cube measured at 0.1 inch on each side, at the time they are introduced. In Table 1, air bubbles are introduced to the base drilling fluid at 100 psig, at 100° F., and the temperature is assumed to remain at 100° F. throughout the table. For this series of computations, 138,609 bubbles were assumed to be introduced per gallon of mixed fluid at 100 psi, thus providing a volume to volume ratio of air to liquid of 60:40 at a pressure of 100 psi. Although the drilling fluid may contain various dissolved and solid additives, the liquid portion of the drilling fluid is assumed, for purposes of the calculations, to be water having a density of 8.33 pounds per gallon. Table I shows the effects of increasing pressures after the bubbles are introduced. Following the Ideal Gas Law, the bubbles are compressed and significantly reduced in size, constantly changing the density of the mixed drilling fluid as the pressure is increased, as normally may be expected as drilling proceeds. Densities in the range of 4-6 pounds per gallon are achieved within the range of 100-200 psig, but approach 8 ppg at 1000 psi. Dissolved air, if any, is not considered in the calculations.

TABLE 1
138,609 bubbles per gallon¹ introduced at 100 psig

| | | | | weight of the | weight of the | |
|---|---|---|---|---|---|---|
| | volume | total area | total volume | liquid portion | air portion of | density of |
| | of one | of all | of all bubbles | of a gallon | a gallon | mixed fluid |
| psig | bubble | bubbles | (cubic inches | (pounds) | (pounds) | (ppg) |
| 100 | 0.001 | 6691.5397 | 138.609 | 3.332021635 | 0.0444385 | 3.376460135 |
| 200 | 0.0005 | 4215.4059 | 69.3045 | 5.831010817 | 0.0444385 | 5.875449317 |
| 300 | 0.000333 | 3216.9567 | 46.203 | 6.664007212 | 0.0444385 | 6.708445712 |
| 400 | 0.00025 | 2655.5393 | 34.65225 | 7.080505409 | 0.0444385 | 7.124943909 |
| 500 | 0.0002 | 2288.4744 | 27.7218 | 7.330404327 | 0.0444385 | 7.374842827 |
| 600 | 0.000167 | 2026.5558 | 23.1015 | 7.497003606 | 0.0444385 | 7.541442106 |
| 700 | 0.000143 | 1828.6364 | 19.80128571 | 7.616003091 | 0.0444385 | 7.660441591 |
| 800 | 0.000125 | 1672.8849 | 17.326125 | 7.705252704 | 0.0444385 | 7.749691204 |
| 900 | 0.000111 | 1546.5515 | 15.401 | 7.774669071 | 0.0444385 | 7.819107571 |
| 1000 | 0.0001 | 1441.6485 | 13.8609 | 7.830202163 | 0.0444385 | 7.874640663 |

¹One gallon = 231.016 cubic inches
2. Density of air at 100 psi is taken as 0.07406417 pounds per gallon
3. 138.609 cubic inches is 60% of the volume of a gallon. Kepler's conjecture precludes more than about 74% of the volume occupied by uniform nontangential bubbles.
4. A bubble having a volume of .001 in³ has a diameter of 0.12407 inch.

### EXAMPLE 2

For the calculations of Table 2, 115,508 bubbles of 0.001 cubic inch were assumed to be introduced into the base drilling fluid (having an assumed density of 8.33 ppg, the density of water) at 500 psi. The density of the air, under a pressure of 500 psi, was already 0.33155 pounds per gallon at the time of introduction. Again, all data assume a constant temperature of 100° F. As in Table 1, the calculations show the effects of increasing pressures, this time beginning at 500 and proceeding to 1500 psig. Densities in the range of 4-7 ppg are achieved.

TABLE 2
115,508 bubbles introduced at 500 psi

| | | | | weight | weight | density of |
|---|---|---|---|---|---|---|
| | volume of one | | total volume | of liquid | of air | mixed |
| pressure | bubble | total surface | of all bubs | in a gallon | in a gallon | Fluid |
| psig | (cubic inch) | of all bubbles | (cubic inch) | (pounds) | (pounds) | (ppg) |
| 500 | 0.001 | 2780.686075 | 115.508 | 4.165 | 0.165775 | 4.330775 |
| 600 | 0.000833333 | 2462.433238 | 96.2566667 | 4.859167 | 0.165775 | 5.024942 |
| 700 | 0.000714286 | 2221.944831 | 82.5057143 | 5.355 | 0.165775 | 5.520775 |
| 800 | 0.000625 | 2032.693852 | 72.1925 | 5.726875 | 0.165775 | 5.89265 |
| 900 | 0.000555556 | 1879.188266 | 64.1711111 | 6.016111 | 0.165775 | 6.181887 |
| 1000 | 0.0005 | 1751.72246 | 57.754 | 6.2475 | 0.165775 | 6.413275 |
| 1100 | 0.000454545 | 1643.880239 | 52.5036364 | 6.436818 | 0.165775 | 6.602594 |
| 1200 | 0.000416667 | 1551.235736 | 48.1283333 | 6.594583 | 0.165775 | 6.760359 |
| 1300 | 0.000384615 | 1470.628789 | 44.4261538 | 6.728077 | 0.165775 | 6.893852 |
| 1400 | 0.000357143 | 1399.737532 | 41.2528571 | 6.8425 | 0.165775 | 7.008275 |
| 1500 | 0.000333333 | 1336.814432 | 38.5026667 | 6.941667 | 0.165775 | 7.107442 |

1. Density of air at 500 psi = 0.33155 ppg.
2. 115.508 cubic inches is one-half gallon.

### EXAMPLE 3

In this calculated example, 115,508 air bubbles of 0.001 cubic inch are introduced at 1000 psig and the pressure is increased in 100 psi increments. As in tables 1 and 2, the air portion of the mixed gallon volume decreases in volume in accordance with the Ideal Gas Law, and the liquid portion increases inversely. The weight of the air is included in the computations to provide the final density in the column titled “density of mixed fluid.” Again, the densities are within the range of 4-8 pounds per gallon, and other values within the range may be projected or interpolated, although, as noted elsewhere herein, amounts of dissolved air are not considered.

TABLE 3
115,508 Bubbles per Gallon Introduced at 1000 psi

| | | | | Weight | weight | |
|---|---|---|---|---|---|---|
| | volume of one | total surface | total volume | of the liq | of the air | density of |
| | bubble | of all bubbles | of all bubs | portion of | portion of | mixed fluid |
| psig | (cubic inch) | (sq. inches) | (cubic inch) | a gallon | a gallon¹ | (ppg) |
| 1000 | 0.001 | 2780.68608 | 115.508 | 4.165 | 0.32754 | 4.49254 |
| 1100 | 0.00090909 | 2609.49722 | 105.007273 | 4.54363636 | 0.32754 | 4.87117636 |
| 1200 | 0.00083333 | 2462.43324 | 96.2566667 | 4.85916667 | 0.32754 | 5.18670667 |
| 1300 | 0.00076923 | 2334.47769 | 88.8523077 | 5.12615385 | 0.32754 | 5.45369385 |
| 1400 | 0.00071429 | 2221.94483 | 82.5057143 | 5.355 | 0.32754 | 5.68254 |
| 1500 | 0.00066667 | 2122.06064 | 77.0053333 | 5.55333333 | 0.32754 | 5.88087333 |
| 1600 | 0.000625 | 2032.69385 | 72.1925 | 5.726875 | 0.32754 | 6.054415 |
| 1700 | 0.00058824 | 1952.1777 | 67.9458824 | 5.88 | 0.32754 | 6.20754 |
| 1800 | 0.00055556 | 1879.18827 | 64.1711111 | 6.01611111 | 0.32754 | 6.34365111 |
| 1900 | 0.00052632 | 1812.65949 | 60.7936842 | 6.13789474 | 0.32754 | 6.46543474 |
| 2000 | 0.0005 | 1751.72246 | 57.754 | 6.2475 | 0.32754 | 6.57504 |
| 2100 | 0.00047619 | 1695.66126 | 55.0038095 | 6.34666667 | 0.32754 | 6.67420667 |
| 2200 | 0.00045455 | 1643.88024 | 52.5036364 | 6.43681818 | 0.32754 | 6.76435818 |
| 2300 | 0.00043478 | 1595.87941 | 50.2208696 | 6.51913043 | 0.32754 | 6.84667043 |
| 2400 | 0.00041667 | 1551.23574 | 48.1283333 | 6.59458333 | 0.32754 | 6.92212333 |
| 2500 | 0.0004 | 1509.58865 | 46.2032 | 6.664 | 0.32754 | 6.99154 |
| 2600 | 0.00038462 | 1470.62879 | 44.4261538 | 6.72807692 | 0.32754 | 7.05561692 |
| 2700 | 0.00037037 | 1434.08905 | 42.7807407 | 6.78740741 | 0.32754 | 7.11494741 |
| 2800 | 0.00035714 | 1399.73753 | 41.2528571 | 6.8425 | 0.32754 | 7.17004 |
| 2900 | 0.00034483 | 1367.37184 | 39.8303448 | 6.8937931 | 0.32754 | 7.2213331 |
| 3000 | 0.00033333 | 1336.81443 | 38.5026667 | 6.94166667 | 0.32754 | 7.26920667 |

¹Assumed density of air at 1000 psi = 0.65508 ppg.

It will be seen from tables 1, 2, and 3 that introducing bubbles at pressures significantly higher than atmospheric enables the production of drilling fluids having densities significantly less than 8 pounds per gallon. While doubling the pressure thereafter will reduce the volume of bubbles by half (note that, in Table 3, the air occupies only one-fourth of the paradigmatic gallon at 2000 psi), the total surface area of the bubbles is not reduced at the same rate, as the surface is a square function of the radius while the volume is a cube function. The surface area of the bubbles is significant for enhancing the flow characteristics of the drilling fluid.

Tables 1, 2, and 3 assume that the bubbles continue to exist as bubbles throughout even though they may become very small. Any air which is dissolved in the fluid is not considered; that is, dissolved air may be present in addition to the free air bubbles. The tables may therefore be used as a rule of thumb, recognizing that Henry's Law requires that at least some air will be dissolved. The dissolution rate will be affected, however, not only by the vagaries of Henry's Law, but also by the other ingredients of the drilling fluid, dissolved or not. Dissolved salts generally may be expected to reduce the air dissolution rate, while bubbles may be attracted to suspended solids. Another caveat about the tables is that the volumes of the bubbles at higher pressures will be compressed to approach colloidal size, and various additional phenomena of colloid chemistry and physics may affect the basic relationships represented in the tables.

Tables 1, 2, and 3 are included to illustrate the effects of downhole pressures on the volume of gas and the density of the fluid treated with it. As predicted by the Ideal Gas Law, whatever the pressure of the gas when it is introduced, if the pressure is doubled downhole, the volume of the gas will be cut in half, and the density increased accordingly. My invention contemplates introducing the bubbles at a pressure of at least 100 psi so that a desired density can be attained at a much higher downhole pressure than would be the case if the bubbles were introduced at atmospheric pressure.

Generally, small bubbles are more desirable than large bubbles, as they will not coalesce as easily as larger ones, and dispersions of smaller bubbles are known to be more stable than dispersions of larger ones. Most commonly, I may generate bubbles in the drilling fluid having diameters from 100 nanometers to 100 micrometers, more broadly in the range of 50 nanometers to 200 micrometers, which I will refer to herein as “microbubbles.”

A distinct advantage of microbubbles in my invention is that, because they are more numerous for a given volume of gas and have a larger total surface area for a given gas volume (surface area is a square function for a bubble and volume is a cube function), they will provide a significant reduction in friction in the drill pipe. Not only are microbubbles more numerous, but the ratio of surface area to volume is greater for a given volume of gas distributed in more but smaller bubbles. Friction reduction in the hydrocarbon recovery art, typically accomplished by water soluble polymer additives, has been recognized for decades as a highly desirable way of conserving and reducing the energy required to pump fluids through long series of pipes. A related property of the microbubbles is that they provide a consistent texture to the fluid. Their uniformity leads to excellent dispersion, in turn enhancing flowability and minimizing coalescence.

My invention obviates the daunting problems presented by injecting bubbles at atmospheric pressure.

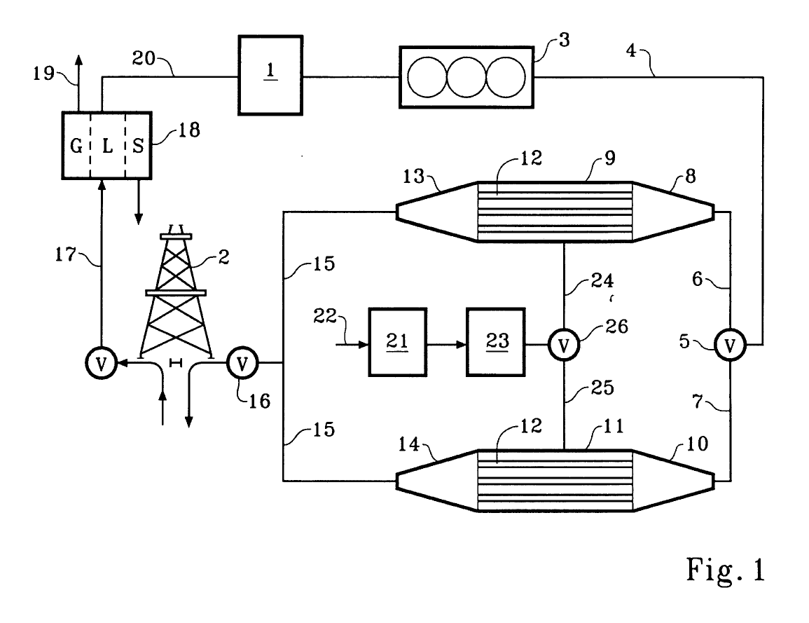

In FIG. 1, a tank 1 or other container holds the base drilling fluid to be used in well 2, and which is to be reduced in weight by the invention. The base drilling fluid is sent to triplex pump 3 which transmits it through line 4 under very high pressure to valve 5. Valve 5 may direct it either to line 6 or line 7 or both. Line 6 leads to the intake header 8 of membrane tube vessel 9, and line 7 leads to intake header 10 of membrane tube vessel 11. Membrane tube vessels 9 and 11 are shown more or less diagrammatically in section so the disposition of membrane tubes 12 can be shown. A plurality of membrane tubes 12 in each of membrane tube vessels 9 and 11 connects with intake headers 8 and 10 respectively, and they connect with outlet headers 13 and 14. Within the membrane tube vessels 9 and 11, there is a void space between membrane tubes 12. The fluid under pressure thus passes through the membrane tubes 12 and the outlet headers 13 and 14 (or, if only one vessel is in operation, it passes through only that vessel) and connects with conduit 15, which leads, through valve 16 to the drill pipe string. The fluid is then circulated to the bottom of the well where it picks up drill cuttings in the conventional manner (except for the weight of the fluid as imparted by the invention) and is returned through line 17 to one or more gas, liquid and solid separators, represented by separator 18. The gas is separated and released or sent through line 19 for capture and reuse (usually if it is a gas other than air, such as nitrogen). Solids may be separated by filters, settling, or in other conventional ways. The liquid is sent by line 20 to the drilling fluid tank 1, where it may be ready to be used again, or it may be sent elsewhere for reconditioning for reuse or storage.

Gas compressor 21 takes in a gas, usually air from the atmosphere, nitrogen, or oxygen-depleted air, at intake 22, compresses it to a high pressure, and sends it to an optional booster 23, which sends it to lines 24 and 25 leading to the void space in the interiors of the membrane tube vessels 9 and 11. If only one vessel is operating, valve 26 will direct it to that vessel.

The membrane tubes 12 are, or can be, filter tubes having membranes on the outside of a porous support. For my purposes, the outer membrane surface may be called the gas side and the internal side may be called the permeate side. The membranes will have pores of from 100 nanometers (or even smaller) to 100 micrometers in diameter, or desirably from 0.1 to 50 microns. A transmembrane pressure difference of 100 psi is sufficient to transport bubbles copiously from the void space inside the vessel—actually filled with very high pressure gas—from the gas side of the membrane through the permeate side, through the porous support and into the flowing, high pressure liquid within the membrane tubes. Transmembrane pressure differences ranging from 50 to 150 psi will not damage most commercially available membrane tubes even though the pressure on both sides of the membrane and its support may exceed 4000 psi.

While the flow sheet of FIG. 1 includes some valves, it should be understood that in practice the system will be engineered to include not only additional pumps and valves at various points but also that monitors, gauges, and transducers for reading pressures, flows, and temperatures, or even weight, will be employed together with controllers, computers and the like to assure safety and carry out the desired procedures such as regulating valves, pumps and the like. A particularly desirable portion of the control system will maintain the desired transmembrane pressure difference, for example in the range of 50 to 150 psi. This means pressure readings should be taken continuously or intermittently of both the fluid within the membrane tubes 12 and the air or other gas in the void spaces between them in the membrane tube vessels 9 and 11. While the rate of diffusion through the membranes is directly related to the transmembrane pressure difference, the volume of gas bubbles taken in per gallon of fluid is also directly related to the flow rate of fluid through the membrane tubes; accordingly the fluid flow rate should be included in the computations of the computer or controller.

The number of membrane tubes 12 in a membrane tube vessel may vary; we have found that fourteen membrane tubes having internal diameters of 0.5 inch to 3 inches are satisfactory. The membrane tube vessels 9 and 11, and headers 2 and 3 are constructed and sealed to withstand the expected pressures as high as 100 or 250-5000 psi.

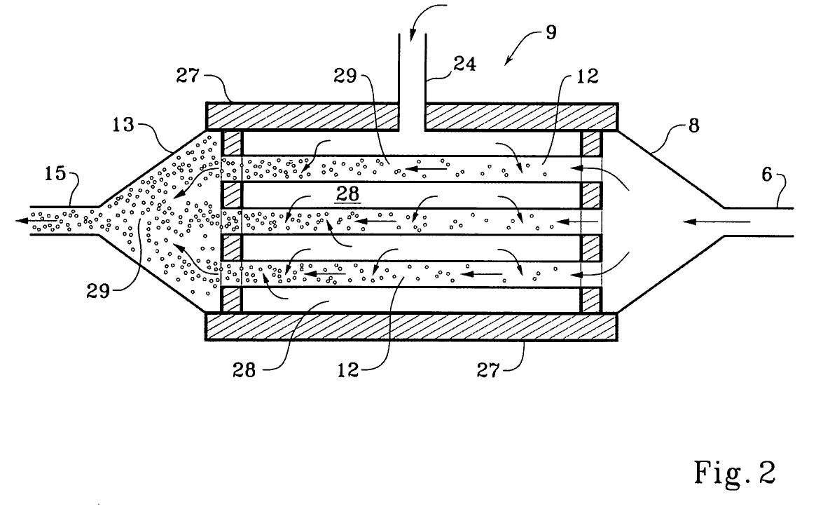

Referring now to FIG. 2, liquid base drilling fluid is introduced from line 6 into header 8 of membrane tube vessel 9 and distributed to the interiors of membrane tubes 12. As explained elsewhere herein, membrane tubes 12 are hollow porous tubes comprising a porous support and a membrane surface, in this case covering their outsides. The ends of membrane tubes 12 are sealed tightly to housing 27, header 8, and collector 13, leaving a void 28 within the housing 27 through which the membrane tubes 12 pass. Air or other gas enters through line 24 and fills the void 28. The drilling fluid in line 6 and within the vessel 27 may be under a high pressure, such as one anywhere from 100 to 5000 pounds per square inch. The air or other gas in line 24 and the interior (void) of housing 27 is maintained at a pressure somewhat higher than that of the fluid in order to provide a positive transmembrane pressure difference of 50 to 150 psi, or other acceptable difference depending on the membrane, the gas, and other factors, as mentioned elsewhere herein. As depicted in the flow of fluid in membrane tubes 12 from right to left, the drilling fluid receives microbubbles which are passed through the walls of the membrane tubes 12, and then the fluid, now containing numerous bubbles 29, passes into the collector 13 and on to line 15 for use in the well.

Membrane vessels such as membrane vessel 9 can be deployed in series as well as the parallel configuration seen in FIG. 1. In this case, it should be recognized that, where the fluid has taken on a significant increase in volume due to the addition of numerous microbubbles, the total flow rate will tend to increase. For example, if the volume of the fluid at the exit of the membrane vessel is 80% liquid and 20% undissolved air instead of 100% liquid, and the pressure and flow rate of the fluid at the entrance to the membrane vessel remains constant, the volume of the fluid has increased by 25%, and accordingly the flow rate must increase by 25%. The flow rate established by the triplex pump 3 may be adjusted accordingly.

### EXAMPLE 4

In a test, a unit similar to schematic vessel 9 in FIG. 1 and FIG. 2 was supplied with an aqueous fluid at 300 gallons per minute. That is, 300 gallons per minute entered a pipe similar to the entrance 6 of FIG. 2 and was sent through the membrane vessel as described for FIGS. 1 and 2. Back pressure was applied to elevate the pressure within membrane tubes similar to membrane tubes 12 of FIG. 2 while the flow was maintained. Air was introduced into the void 28, brought up to a pressure greater than 1500 psi, and flow of air into the vessel 9 was established and maintained at 1000 standard cubic feet per minute. Not having any other exit, the air passed through the membrane tube walls into the fluid and continued to do so as the air was continuously supplied at 1000 scfm. When the fluid pump was suddenly disconnected to provide a sudden depressurization within the membrane tubes, they did not collapse.
In a second test, similar pressures and flow rates were established and maintained for a period of time, also successfully incorporating microbubbles in the fluid, but in this instance, the air pressure was suddenly terminated, and no damage to the tubes was observed.

As demonstrated in Example 4, the membrane tubes may be subjected to transmembrane pressure differences substantially greater than 150 psi, making practical the use of microporous (membrane) materials necessitating large pressure drops across them, such as membranes having extremely minute pores.

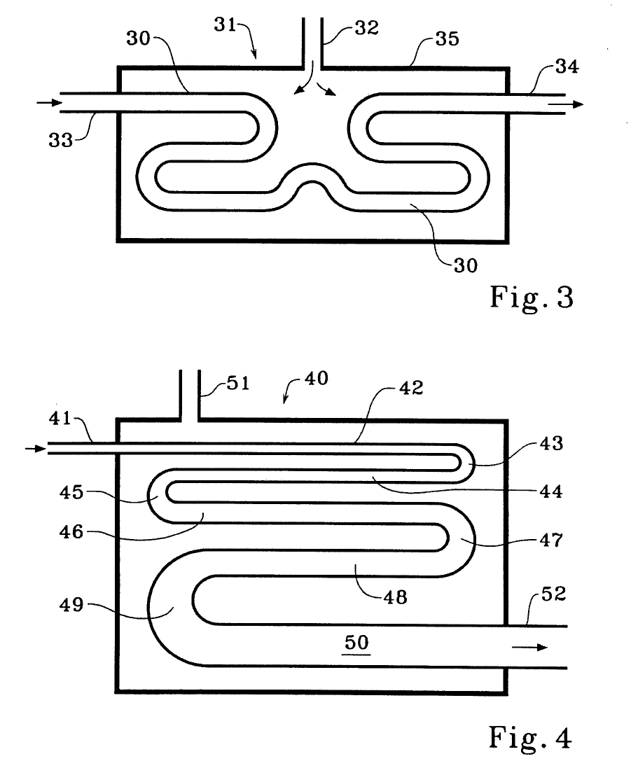

FIG. 3 provides a possible improvement over the linear flow of the designs of FIGS. 1 and 2. In FIG. 3, a membrane tube 30 follows a tortuous path through the membrane tube vessel 31, which is filled with pressurized air (or other gas) introduced through line 32. Tortuosity in the flow of the fluid will impart turbulence and mixing of the microbubbles into the fluid as it flows from entrance 33 to exit 34, otherwise similar to the lines 6 and 15 of FIG. 2. Turbulence increases the likelihood that a bubble will be transported from the membrane tube wall immediately on its formation, moving into the interior of the stream instead of possibly following a laminar flow pattern along the wall of the tube. The improved dispersion of bubbles enhances the uniformity of the fluid characteristics almost immediately, leading to a desirable smooth texture. A plurality of such tortuous membrane tubes 30 having membranes on their outside surfaces may of course be housed in a housing such as housing 35, and it may be equipped with a header similar to header 8 in FIG. 2 and a collector such as collector 13 in FIG. 2. Curves in more than one plane, helixes and the like different from the tortuous path depicted in FIG. 3 may be used.

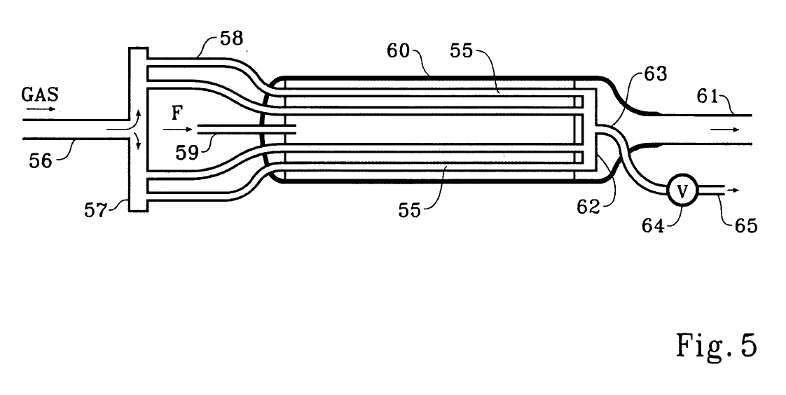

FIG. 4 shows several membrane tube sections in series within a vessel wherein each succeeding membrane tube has a diameter greater than the diameter of the previous one. This will provide for the increasing volume of the fluid as it takes in air in the form of microbubbles, and provide a greater degree of control over the flow and pressure of the fluid as it leaves the membrane tube vessel and proceeds to the well. Base drilling fluid enters the membrane tube vessel 40 through line 41 and flows into a first section 42 of membrane tube having a diameter similar to line 41. First section 42 ends at curve connector 43 which leads to a second section 44 of membrane tube having a diameter slightly larger than that of first section 42. Second section 44 in turn ends at curve connector 45, which takes the fluid to third section 46 of membrane tube, again having a diameter larger than previous section 44. The fluid proceeds through curve connector 47, fourth membrane tube section 48, curve connector 49, membrane tube section 50, and finally to exit 51. As in the other configurations of membrane vessels depicted herein, a gas (perhaps air, nitrogen, or oxygen-depleted air) able to pass through the membrane tube walls and form microbubbles in the fluid, is introduced under pressure through conduit 51. Again, as the fluid within the membrane tubes may already be under a high pressure (perhaps 2000 psi or more), the air or other gas is maintained at a pressure somewhat higher.

The system is also dynamic in that the size of the microbubbles will tend to vary with the transmembrane pressure difference, which in turn is affected by changes in flow rate due to the increase in volume of the fluid as gas is taken in by the fluid. Assuming a constant back pressure from the well, a downstream pump, or a pressure regulator, an increase in fluid volume will tend to reduce the velocity of the fluid, which can decrease the transmembrane pressure difference; if, however, the flow rate, in pounds per gallon, after introduction of gas, remains the same as that before introduction of gas, the fluid's velocity will increase, tending to reduce the pressure on the fluid side of the membrane and accordingly increase the transmembrane pressure difference somewhat, thus encouraging the introduction of more gas. Quite apart from the velocity of the fluid as affecting the pressure on the fluid side, gas intake by a volume of fluid is a function (among many others) of the velocity of the fluid simply because more or less fluid contacts the membrane surface per unit of time as the velocity of the fluid is varied. Thus both bubble size and the volume of gas taken in per gallon of liquid (fluid) are affected by fluid velocity, and accordingly the operators may wish to adopt appropriate controls for transmembrane pressure differences to achieve the desired results as fluid demand and pressures respond to the needs of the drilling project.

Membrane tube segments of increasing diameters need not be in the same membrane tube vessels. For example, several membrane tubes of the diameter of tube 41 could be in a vessel, and each of them could lead to a second vessel to connect with tubes of the diameter of membrane tube 44; these could connect to larger tubes in a third vessel, and perhaps more. It is also possible to employ tubes having gradually increasing diameters. When engineering such flights of membrane tubes or otherwise using increasingly larger diameters, the total membrane surfaces should also be considered. That is, not only is the fluid increasing in volume as it takes in bubbles, the ratio of the membrane surface area (assuming all available surface area is covered with membrane) will change, since the membrane surface area will increase as a linear function of the cylindrical radius, while the volume of fluid will increase as a square function of the cylinder's radius. FIG. 4 should not necessarily be considered in accurate proportion for a practical unit; in particular, the increasing diameters of the membrane tubes are exaggerated for illustrative purposes.

In FIG. 5, the membrane surfaces are on the insides of the membrane tubes 55. Drilling fluid under pressure passes from line 59 into the membrane tube vessel 60, occupying the space next to and around membrane tubes 55, from which it picks up microbubbles moving through the walls of membrane tubes 55, and passes out exit 61. Pressurized air or other gas enters from conduit 56 where, in this configuration, it enters header 57 having leads 58 leading to membrane tubes 55, each of which has membrane on its inside surface or otherwise is able to transmit the gas from tubes 55 to the fluid within membrane tube vessel 60. In this version, membrane tubes 55 meet at connection 62, having a single exit line 63. On line 63 is a valve 64 and a further line 65 which may direct any remaining gas to a different use or location, or simply bleed. FIG. 5 is to illustrate that the membrane may be on the inside of the membrane tube, while the fluid contacts the outside, and any hollow porous support structure would be external to the membrane. As with the previously seen membrane tubes, these may also induce turbulence by tortuous paths, and they may be deployed in various successions to accommodate the increasing volume of the fluid as it picks up gas, changing flow rates, and other dynamics of the system. Gas or air not transported through the walls of membrane tubes 55 may continue to pass through valve 64, but valve 64 may be completely closed, thereby providing a dead end for the gas or air, frequently making it easier to regulate the pressure and to measure the amount of air introduced into the fluid. If it is desired to consume substantially all gas or air in the membrane tubes, they may be designed as dead-end tubes, and a valve is in that case unnecessary Dead-end tubes may be, but need not be, connected at their ends as at connection 62.

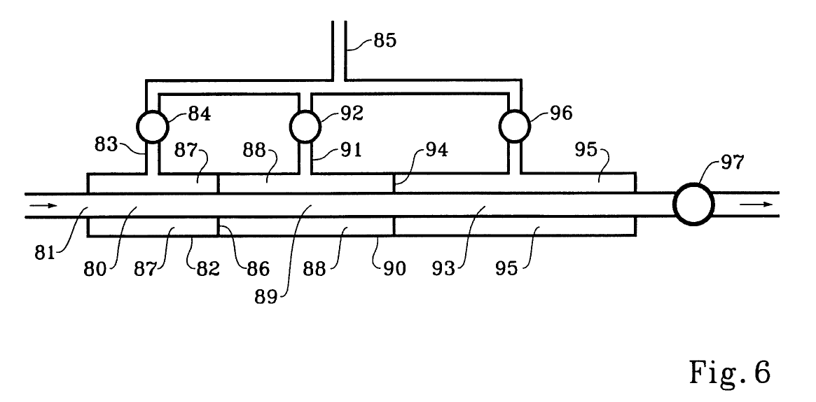

In FIG. 6, a variation of the microbubble machine is constructed to take into account the increase in volume of the drilling fluid as it takes in gas. The microbubble machine in this case may be only one of several similar units in series or parallel. Base drilling fluid enters a first membrane tube segment 80 at entrance 81. First membrane tube segment 80 has an external membrane surface (or, if the microporous medium is self-supporting, it is able to pass microbubbles from the outside to the inside of the membrane tube segment, or channel) and is encased in a pressurized housing 82 having an inlet 83 for pressurized gas, admitted by valve/regulator 84 from pressurized gas source 85. Gas bubbles therefore enter the fluid within membrane tube segment 80 as explained elsewhere herein. Secured to housing 82 and membrane tube segment 80 is a divider 86, sealing off the gas in the space 87 from gas in space 88 surrounding second membrane tube segment 89. Second membrane tube segment 89 also has a housing 90 and an inlet 91 for pressurized gas leading from valve/regulator 92 which in turn obtains its pressurized gas from source 85. Second membrane tube segment 89 similarly connects to third membrane tube segment 93 through divider 94 which seals off space 95 from space 88 around second membrane tube segment 89. Third membrane tube segment 93 has its own source of pressurized gas from valve/regulator 96. Membrane tube segments 80, 89, and 93 are shown to be of different lengths. Although this is not essential, it provides a way of compensating for the increase in volume as the drilling fluid proceeds through the machine. Although a constant pressure may be assured by a pump or pressure regulator 97, the tendency of the fluid to increase in volume as it proceeds through the membrane tube device will tend to increase its velocity, thus tending to reduce the pressure on the outside wall of the membrane tubes, in turn increasing the rate of gas introduction. Gas pressure in space 88 may be held at a different, usually lower, value than that in space 87, and in turn the gas pressure in space 95 may be somewhat different, usually lower, than that of space 88.

The formation of microbubbles can be enhanced by adding surfactants. Since I do not want foam I use surfactants that reduce the interfacial tension between the gas and liquid to encourage the introduction of the gas into the liquid, without creating voluminous foam structures which, even if they have small cells, may require increased drainage times and otherwise defeat my purposes. Such surfactants could include various products that have a low HLB (hydrophile-lipophile balance) such that they disperse in water, or are only slightly soluble in water. Surfadone LP-300 (octyl pyrrolidone) from ISP is useful; however, there are a number of lipophilic products that should work. Surfactants having a low HLB (lipophilic surfactants) are added to the drilling fluid in amounts effective to reduce the interfacial tension between the gas and liquid.

Further, the stability of the micro bubble suspension can be enhanced by increasing the viscosity using conventional drilling polymers such as xanthan gum, hydroethylcellulose, starches, carboxymethylcellulose and other cellulose derivatives. Polymers which enhance the viscosity of aqueous drilling fluids are referred to herein as viscosity-enhancing polymers. Increasing the viscosity of the drilling fluid will reduce the mobility of the bubbles and reduce the likelihood they will contact each other and coalesce, thus reducing the ratio of surface area to volume. The viscosity-enhancing polymers are added to the drilling fluid in amounts effective to enhance the viscosity of the drilling fluid.

Although the light weight drilling fluids made by my process have an excellent texture due to the small size and substantially uniform size distribution, the stability of the micro bubble suspension can be enhanced by adding an electrical charge to the surface of each bubble. Micro bubbles are being used extensively in the medical profession where stability is important. A number of additives are listed in the literature as being stabilizers for micro-bubble suspensions. One such stabilizer is poly (allylamine hydrochloride) or PAH. An effective stabilizer I use is a copolymer of DADMAC/AA (diallyldimethylammonium chloride and acrylic acid). The quaternized ammonium groups impart a strong cationic charge at the bubble surface; however, any polymer capable of carrying an ionic charge may be used. Essentially I take advantage of electrokinetics and electrophoresis phenomena commonly referred to as Zeta Potential. Much as similar poles of magnets will repel one another, similarly charged bubble surfaces will repel one another and help stabilize the dispersed suspension of bubbles. I add the suspension stabilizers to the drilling fluid in amounts effective to stabilize the suspension of bubbles.

Since water is practically incompressible, a given density can be calculated by first picking a target weight in pounds per gallon. To obtain a certain ppg fluid, one solves (1−desired density/liquid density) to find the volume of gas required; however, one must determine the volume of gas knowing or estimating the pressure using the Ideal Gas Law, PV=RT.

Normally drilling fluids heavier than water are prescribed in order to increase the specific gravity and provide enhanced buoyancy for the drill cuttings picked up by the fluid. Therefore it would seem to be counterintuitive to add microbubbles to such a fluid to reduce its weight; however, the same equation, and my invention, works whether one uses water or clear brine having a high density. In addition to friction reducing, an advantage of microbubbles in a dense clear brine may be that the bubbles may give more “lift” as the heavy fluid is returned up the wellbore. Thus my invention is able not only to reduce the weight of more or less conventional aqueous drilling fluids, but also fluids which are made dense for various reasons by the addition of heavy salts, such as for stabilizing drilling operations when drilling through formations having high salt content.

I use the terms liquid and base liquid and fluid for their ordinary meanings and for their meanings in the art of drilling wells. It should be understood also that since I do not intend to make foam, the terms non-contiguous and/or non-foam are intended to mean that the microbubbles are dispersed and do not contact each other in significant numbers.

There are numerous membranes and membrane-like materials available in the market. I use the term membrane to include not only the traditional or classic meaning but also to embrace any of the numerous synthetic and other materials available having the ability to pass and/or other gases through them; particularly they will be able to pass such gases through themselves and form microbubbles within an aqueous fluid on the permeate side. A membrane tube may have a membrane surface on either its interior or its exterior, which may be supported by a porous base (support) or self-supporting. When gas is intended to pass through the membrane tube wall from the outside to the inside, as depicted in FIGS. 1-4, both ends of the membrane tubes will be open in order to permit the fluid to pass through them. When gas is intended to enter the interior of a membrane tube, it may be a “dead-end.” In this case, and where valve 64 is closed in FIG. 5, it may be assumed that all of the air or gas will pass through the membrane and enter into the fluid.

Suitable membrane tubes are made by GKN Sinter Metals; in particular I may use the type SIKA-R. These are porous metal elements combining the support and porous properties of, for example, membrane tubes having a porous polymeric base and a porous polymeric membrane laid on them.

I use the term membrane tube throughout to include not only the common tubular or cylindrical form, but also a device of any shape which permits a gas to pass through the wall of the shape into a flowing fluid (liquid) on the other side, under an appropriate pressure difference. For example, the device may be rectangular or another shape in cross section and have a planar, concave, convex, or other membrane surface on all or only part of it. If it is constructed so the gas can permeate from the inside out, it can be a “dead end” device.

Typically the circulating pressure of the well will be 100 or 250 to 5000 psi.

The gas may be air, nitrogen (at least 90%), or any other convenient gas. Permselective membranes may be used—that is, a membrane may be used which is able to permit only or primarily a desired gas molecule through it under the prevailing conditions. For example, a permselective membrane able to pass bubbles of a nitrogen-rich portion of air from air would generate microbubbles of such nitrogen-rich gas in the drilling fluid, which could be desirable to reduce oxidation and/or the risk of explosions.

1. Method of reducing the weight of a liquid well drilling fluid comprising (a) maintaining said drilling fluid at a pressure of at least 100 psi, and (b) passing a gas through a microporous medium into said well drilling fluid in the form of microbubbles, thereby reducing the weight of said well drilling fluid.

2. Method of claim 1 including flowing said well drilling fluid through a microporous membrane tube comprising said microporous medium.

3. Method of claim 2 whereby the weight of said well drilling fluid is reduced at least 20%.

4. Method of claim 2 wherein the weight of said drilling fluid is reduced to a weight in the range of four to eight pounds per gallon.

5. Method of claim 1 wherein the microbubbles have diameters from 100 nanometers to 100 micrometers

6. Method of claim 1 wherein said microporous membrane is fixed in a microporous membrane tube having pores of 0.1 to 50 microns and said drilling fluid flows through said microporous membrane tube in a cross flow mode.

7. Method of claim 1 wherein said gas is air.

8. Method of claim 1 wherein said gas is at least 90% nitrogen.

9. Method of claim 1 wherein said liquid well drilling fluid contains at least one of (c) a surfactant in an amount effective to reduce the interfacial tension between the gas and the aqueous fluid (d) a viscosity-enhancing polymer in an amount effective to enhance the viscosity of said aqueous drilling fluid, and (e) a suspension stabilizer in an amount effective to stabilize the suspension of microbubbles in said aqueous drilling fluid.

10. Method of claim 1 including maintaining a pressure difference across said microporous medium of between 50 and 150 psi

11. Method of injecting a liquid drilling fluid having a reduced density into a wellbore at a pressure in excess of 250 psi comprising (a) contacting said drilling fluid at a fluid pressure of at least 250 psi with a microporous membrane and (b) introducing microbubbles of gas into said fluid to reduce the density of said fluid by permeating said gas through said microporous membrane, said gas being under a pressure greater than the pressure of said liquid drilling fluid, and (c) injecting said drilling fluid into said wellbore.

12. Method of claim 11 wherein (d) said contacting of said drilling fluid with said microporous membrane comprises flowing said drilling fluid through at least one tube comprising said microporous membrane and wherein (e) said permeating of said gas through said microporous membrane comprises contacting the exterior of said at least one tube with said gas at a pressure in excess of 250 psi.

13. Method of claim 12 wherein said at least one tube has a tortuous flow pattern.

14. Method of claim 11 wherein (d) said contacting of said drilling fluid with said microporous membrane comprises flowing said drilling fluid in contact with the outside of at least one tube comprising said microporous membrane and wherein (e) said permeating of said gas through said microporous membrane comprises contacting the inside of said at least one tube with said gas at a pressure in excess of 250 psi.

15. Method of drilling a well comprising (a) imposing a pressure suitable for drilling a well on a drilling fluid, said pressure being at least 100 psi, (b) creating microbubbles of gas in a said drilling fluid while under pressure by passing gas into said fluid through a microporous membrane, thereby reducing the density of said fluid by at least 20 percent; (c) circulating said fluid containing said gas to said well to remove drill cuttings therefrom, (d) recovering said fluid from said well, and (e) removing said drill cuttings from at least a portion of said fluid to make a recycle fluid.

16. Method of claim 15 wherein said creating microbubbles in step (b) comprises maintaining a transmembrane pressure difference between 50 and 150 psi.

17. Method of claim 15 including (f) creating microbubbles of gas in at least a portion of said recycle fluid by passing gas into it through a microporous membrane, and (g) using said at least a portion of said recycle fluid containing said gas as a drilling fluid.

18. Method of claim 17 wherein said pressure in step (a) is at least 1000 psi.

19. Method of claim 15 wherein said microbubbles have diameters from 100 nanometers to 100 micrometers.

20. Method of claim 15 wherein said drilling fluid contains at least one of (i) a surfactant in an amount effective to reduce the interfacial tension between the gas and the aqueous fluid (ii) a viscosity-enhancing polymer in an amount effective to enhance the viscosity of said aqueous drilling fluid, and (iii) a suspension stabilizer in an amount effective to stabilize the suspension of microbubbles in said aqueous drilling fluid.
